(19) United States
(12) Patent Application Publication
(10) Pub. No.: US 2017/0214658 A1
(43) Pub. Date: Jul. 27, 2017

(54) DEVICE TO DETECT AND DROP POTENTIALLY DANGEROUS PAYLOADS RECEIVED OVER-THE-AIR ON WIRELESS DEVICES

(71) Applicant: QUALCOMM Incorporated, San Diego, CA (US)

(72) Inventors: Daniel Godas-Lopez, San Diego, CA (US); Arun Balakrishnan, San Diego, CA (US); Kenneth Chen, San Diego, CA (US)

(21) Appl. No.: 15/004,844

(22) Filed: Jan. 22, 2016

(51) Int. Cl. H04L 29/06

(52) U.S. Cl. CPC H04L 63/0263; H04L 63/0236; H04L 63/0245

(57) ABSTRACT

Aspects of the disclosure are related to a method for installing one or more filtering rules, comprising: receiving the filtering rules; and installing the filtering rules into a mobile network modem, in which each filtering rule may be associated with a layer of an over-the-air (OTA) protocol stack and specifies a type of payload and one or more conditions for the payload.

### FIELD

The subject matter disclosed herein relates, in general, to electronic devices, and in particular, to an apparatus, system, and method for filtering over-the-air payloads in a mobile network modem.

### BACKGROUNDS

Wireless devices with mobile network access (e.g., access to one or more of Global System for Mobile Communications “GSM” network, Code Division Multiple Access “CDMA” network, Universal Mobile Telecommunications System “UMTS” network, CDMA2000 network, or Long-Term Evolution “LTE” network, and the like) are susceptible to attacks against over-the-air (OTA) protocol stacks. Malicious OTA payloads, if received and processed by a mobile network modem, may exploit vulnerabilities in the OTA protocol stacks (a protocol stack may be a GSM protocol stack, a CDMA protocol stack, a UMTS protocol stack, a CDMA2000 protocol stack, an LTE protocol stack, etc.) and therefore may cause behaviors in the mobile network modem or in the wireless device that comprises the mobile network modem that are unwanted by the legitimate operator/user. Known mobile network modems may provide implementation of a full OTA protocol stack and may be capable of parsing incoming OTA payloads and may split them into payloads at the different layers of the protocol stack.

However, due to different interpretations and implementations of mobile network standards, it is also possible that OTA payloads without any malicious intent cause instability and/or prevent normal functioning in the mobile network modem and/or the wireless device that comprises the mobile network modem.

### SUMMARY

An aspect of the disclosure is related to a method for installing one or more filtering rules, comprising: receiving the filtering rules; and installing the filtering rules into a mobile network modem, in which each filtering rule may be associated with a layer of an over-the-air (OTA) protocol stack and specifies a type of payload and one or more conditions for the payload.

Another aspect of the disclosure is related to a device, comprising: a mobile network modem; a memory; and a processor coupled to the memory, the processor to: receive one or more filtering rules, and install the filtering rules into the mobile network modem, in which each filtering rule may be associated with a layer of an over-the-air (OTA) protocol stack and specifies a type of payload and one or more conditions for the payload.

Yet another aspect of the disclosure is related to an apparatus for installing one or more filtering rules, comprising: means for receiving the filtering rules; and means for installing the filtering rules into a mobile network modem, in which each filtering rule may be associated with a layer of an over-the-air (OTA) protocol stack and specifies a type of payload and one or more conditions for the payload.

Still another aspect of the disclosure is related to a non-transitory computer-readable medium comprising code which, when executed by a processor, causes the processor to perform a method comprising: receiving one or more filtering rules; and installing the filtering rules into a mobile network modem, in which each filtering rule may be associated with a layer of an over-the-air (OTA) protocol stack and specifies a type of payload and one or more conditions for the payload.

### BRIEF DESCRIPTION OF THE DRAWINGS

FIG. 1 is block diagram illustrating an exemplary device in which embodiments of the disclosure may be practiced.

FIG. 2 is block a diagram illustrating example components that can be utilized according to embodiments of the disclosure.

FIG. 3 is a diagram illustrating an example protocol architecture comprising an LTE OTA protocol stack.

FIG. 4 is a diagram illustrating example filtering rules.

FIG. 5 is a flowchart illustrating an example method for installing filtering rules into a mobile network modem.

FIG. 6 is a flowchart illustrating an example method for filtering incoming OTA payloads.

### DETAILED DESCRIPTION

Aspects of the disclosure are disclosed in the following description and related drawings directed to specific embodiments of the disclosure. Alternate embodiments may be devised without departing from the scope of the disclosure. Additionally, well known elements of the disclosure may not be described in detail or may be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the disclosure. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

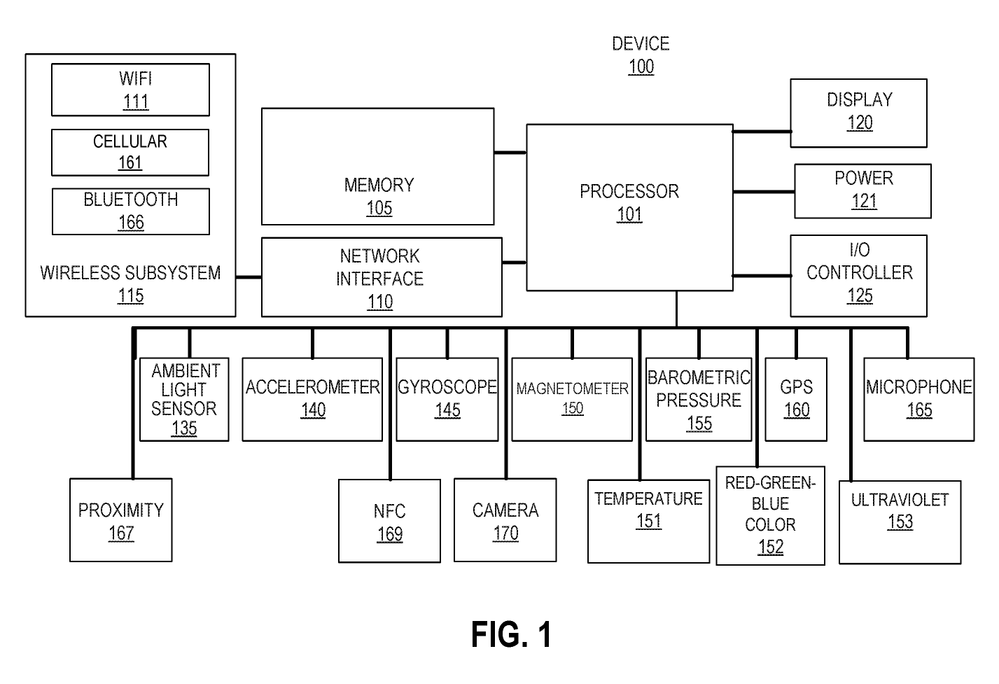

FIG. 1 is block diagram illustrating an exemplary device 100 in which embodiments of the disclosure may be practiced. The device 100 may include one or more processors 101, a memory 105, I/O controller 125, and network interface 110. Device 100 may also include a number of device sensors coupled to one or more buses or signal lines further coupled to the processor 101. It should be appreciated that device 100 may also include a display 120, a user interface (e.g., keyboard, touch-screen, or similar devices), a power device 121 (e.g., a battery), as well as other components typically associated with electronic devices. In some embodiments, device 100 may be a mobile or non-mobile device. Herein “processor” and “data processing unit” are used interchangeably.

The device (e.g., device 100) can include sensors such as ambient light sensor (ALS) 135, accelerometer 140, gyroscope 145, magnetometer 150, temperature sensor 151, barometric pressure sensor 155, red-green-blue (RGB) color sensor 152, ultra-violet (UV) sensor 153, UV-A sensor, UV-B sensor, compass, proximity sensor 167, near field communication (NFC) 169, and/or Global Positioning System (GPS) sensor 160. In some embodiments, multiple cameras are integrated or accessible to the device. For example, a mobile device may have at least a front and rear mounted camera. In some embodiments, other sensors may also have multiple installations or versions.

Memory 105 may be coupled to processor 101 to store instructions for execution by processor 101. In some embodiments, memory 105 is non-transitory. Memory 105 may also store one or more models or modules to implement embodiments described below. Memory 105 may also store data from integrated or external sensors.

Network interface 110 may also be coupled to a number of wireless subsystems 115 (e.g., Bluetooth 166, Wi-Fi 111, Cellular 161, or other networks) to transmit and receive data streams through a wireless link to/from a wireless network, or may be a wired interface for direct connection to networks (e.g., the Internet, Ethernet, or other wired or wireless systems). The mobile device may include one or more local area network transceivers connected to one or more antennas. The local area network transceiver comprises suitable devices, hardware, and/or software for communicating with and/or detecting signals to/from wireless APs, and/or directly with other wireless devices within a network. In one aspect, the local area network transceiver may comprise a Wi-Fi (802.11x) communication system suitable for communicating with one or more wireless access points.

The device 100 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however, in other aspects, the wireless communication system may comprise another type of cellular telephony network or femtocells, such as, for example, TDMA, LTE, LTE Advanced, WCDMA, UMTS, 4G, 5G, or GSM. Additionally, any other type of wireless networking technologies may be used, for example, WiMAX (802.16), Ultra-Wide Band, ZigBee, wireless USB, etc.

Thus, device 100 may be a: mobile device, wireless device, cell phone, personal digital assistant, mobile computer, wearable device (e.g., head mounted display, virtual reality glasses, etc.), robot navigation system, tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 100 may include a radio device, a cellular telephone device, a computing device, a personal communication system device, or other like movable wireless communication equipped device, appliance, or machine. Any operable combination of the above are also considered a “mobile device.”

The mobile device may communicate wirelessly with a plurality of wireless APs using RF signals (e.g., 2.4 GHz, 3.6 GHz, and 4.9/5.0 GHz bands) and standardized protocols for the modulation of the RF signals and the exchanging of information packets (e.g., IEEE 802.11x).

It should be appreciated that embodiments of the disclosure as will be hereinafter described may be implemented through the execution of instructions, for example as stored in the memory 105 or other element, by processor 101 of device and/or other circuitry of device and/or other devices. Particularly, circuitry of device, including but not limited to processor 101, may operate under the control of a program, routine, or the execution of instructions to execute methods or processes in accordance with embodiments of the disclosure. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by device itself and/or some or all of the functions, engines or modules described herein may be performed by another system connected through I/O controller 125 or network interface 110 (wirelessly or wired) to device. Thus, some and/or all of the functions may be performed by another system and the results or intermediate calculations may be transferred back to device. In some embodiments, such other device may comprise a server configured to process information in real time or near real time. In some embodiments, the other device is configured to predetermine the results, for example based on a known configuration of the device. Further, one or more of the elements illustrated in FIG. 1 may be omitted from the device 100. For example, one or more of the sensors 130-165 may be omitted in some embodiments.

Embodiments of the invention relate to installing filtering rules in a mobile network modem, in which each filtering rule may be associated with a layer of an over-the-air (OTA) protocol stack and specifies a type of payload and one or more conditions for the payload. Further, embodiments relate to matching incoming OTA payloads against the filtering rules, and discarding the payloads based on the filtering rules without updating or changing the firmware of the mobile network modem. In one embodiment, the filtering rules may be layer-specific. In other words, each filtering rule may be associated with a specific layer among the different layers of the protocol stack. And hooks may be added to the protocol stack to gain access to payloads at each layer of the protocol stack.

Therefore, at each layer, payloads for the layer may be matched against filtering rules associated with the layer, if any. In one embodiment, a Berkeley Packet Filter may be utilized to find the matching payloads according to the filtering rules. A payload for the layer may be discarded if one of the filtering rules associated with the layer indicates that the payload should be discarded. A discarded payload may be removed from any further processing.

In one embodiment, the filtering rules may be removed (flushed) from the mobile network modem, so that if an incorrectly-constructed filtering rule prevents the normal functioning of the mobile network modem, its effect can be quickly reversed.

In one embodiment, the filtering rules may be compiled into a binary ruleset file, either by a service provider or a device manufacturer. The ruleset file may be digitally signed by its author to ensure its trustworthiness. The ruleset file may be transferred to the wireless device, wirelessly or otherwise, and may be installed into the mobile network modem by the wireless device. The installation of the filtering rules may be achieved through, e.g., a Mobile Station Modem “MSM” Interface (MI). The installed filtering rules may be stored in a permanent storage, such as, a secure file system (SFS) within the mobile network modem. It should be appreciated that the rules may be stored in a permanent storage that does not necessarily need to be secure and may be in a MPSS or APSS, as will be described.

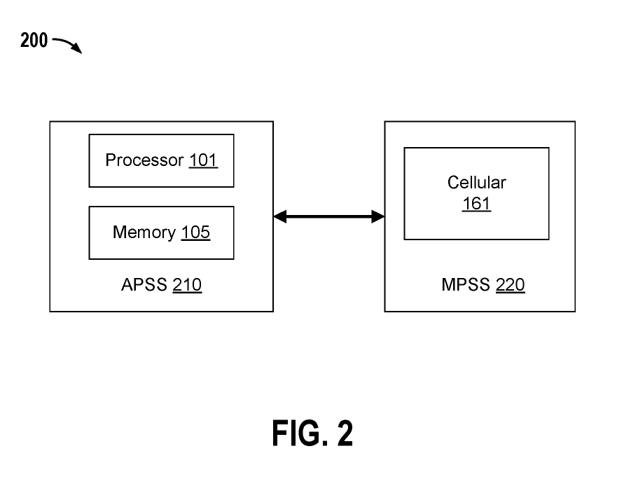

Referring to FIG. 2, a block diagram 200 illustrates example components that can be utilized according to embodiments of the disclosure. The application processor subsystem (APSS) 210 and the modem processor subsystem (MPSS) 220 may be components within the device 100, as described above. In particular, the APSS 210 may comprise the processor 101 and the memory 105 of the device 100. The APSS 210 may be running a high-level operating system (HLOS) such as Android, iOS, or Windows Phone, etc. The MPSS 220 may comprise a cellular modem module 161 within the wireless subsystems 115 of the device 100, which may further comprise, e.g., a baseband processor and an SFS. The MPSS 220 comprises an implementation of a full OTA protocol stack and is capable of parsing incoming OTA payloads and split them into payloads at the different layers of the protocol stack. Under the control of the HLOS, the APSS 210 may communicate with the MPSS 220 through, e.g., the buses of the device 100. In one embodiment, the APSS 210 may communicate with the MPSS 220 using an MI (e.g., through an MI service running on the MPSS 220 and a MI client running on the APSS 210).

Therefore, in one embodiment, the APSS 210, running the HLOS, may receive a binary ruleset file comprising filtering rules from either a service provider or a device manufacturer. The APSS 210 may then install the filtering rules into the MPSS 220 using the MI. The filtering rules may be installed into the MPSS 220 without changing or updating the firmware of the MPSS 220.

The filtering rules may be layer-specific. In other words, each filtering rule may be associated with a specific layer among the different layers of the protocol stack. Once the filtering rules are installed, the MPSS 220 may match payloads at each layer against filtering rules associated with the layer, if any. Within the MPSS 220, hooks may be added to the protocol stack to gain access to payloads at each layer of the protocol stack that is associated with at least one filtering rule. Therefore, payloads at one or more layers of the protocol stack may be accessed through the use of hooks. Any method for matching the payloads against filtering rules may be utilized. In one embodiment, a Berkeley Packet Filter may be utilized by the MPSS 220 to find the matching payloads according to the filtering rules. The MPSS 220 may discard a payload for the layer if one of the filtering rules associated with the layer indicates that the payload should be discarded. A discarded payload is removed from any further processing by the MPSS 220.

In one embodiment, the APSS 210 may, e.g., in response to a user input, remove (flush) the filtering rules that have been installed in the MPSS 220, so that if an incorrectly-constructed filtering rule prevents the normal functioning of the MPSS 220, its effect can be quickly reversed. It should be appreciated that removing the filtering rules may be equivalent to installing an empty ruleset.

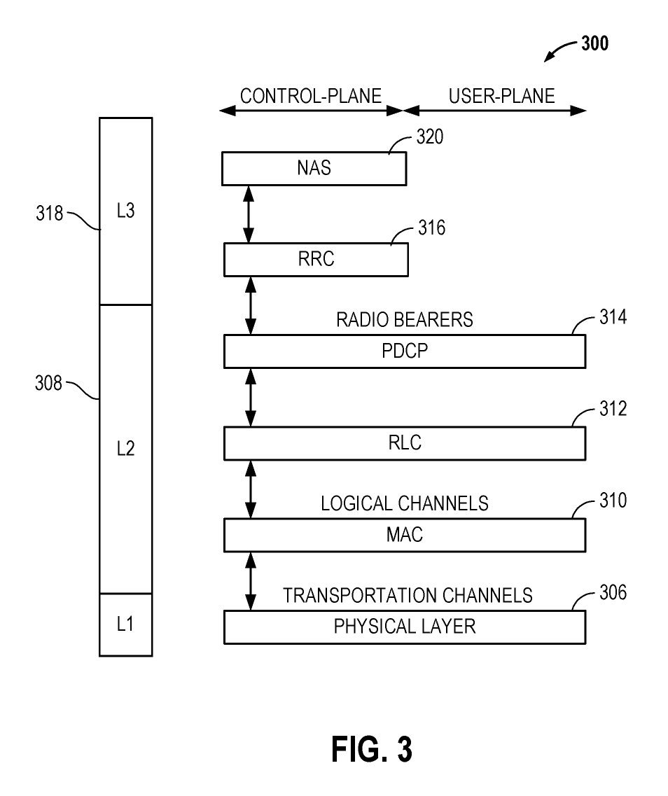

Referring to FIG. 3, a diagram illustrating an example protocol architecture 300 comprising an LTE OTA protocol stack is shown. Although only an LTE protocol stack is shown, the disclosure is not limited to the LTE protocol stack. Embodiments of the disclosure may be adapted for use with other OTA protocol stacks such as a GSM protocol stack, a CDMA protocol stack, a UMTS protocol stack, a CDMA2000 protocol stack, etc. In general, as with the LTE protocol stack, an OTA protocol stack comprises three layers: Layer 1 (Physical Layer), Layer 2 (Data link Layer), and Layer 3 (Network Layer). In FIG. 3, the protocol architecture 300 comprising an LTE protocol stack is shown with the three layers: Layer 1, Layer 2, and Layer 3. Layer 1 (L1) is the lowest level and implements various physical layer signal processing functions. Layer 1 may be referred to herein as the physical layer 306. Layer 2 (L2) 308 is above the physical layer 306 and is responsible for the link between the device 100 and a base station (e.g., an eNodeB) over the physical layer 306. L2 layer 308 is common to control and user planes and includes a media access control (MAC) sublayer 310, a radio link control (RLC) sublayer 312, and a packet data convergence protocol (PDCP) 314 sublayer, which are terminated at the eNodeB on the network side. Although not shown, the device 100 may have several upper layers above L2 layer 308 including a network layer (e.g., IP layer) that is terminated at a packet data network (PDN) gateway on the network side, and an application layer that is terminated at the other end of the connection (e.g., far end user equipment, server, etc.) The PDCP sublayer 314 provides multiplexing between different radio bearers and logical channels. The PDCP sublayer 314 also provides header compression for upper layer data packets to reduce radio transmission overhead, security by ciphering the data packets, and handover support for pieces of user equipment between eNodeBs. The RLC sublayer 312 provides segmentation and reassembly of upper layer data packets, retransmission of lost data packets, and reordering of data packets to compensate for out-of-order reception due to hybrid automatic repeat request (HARQ). The MAC sublayer 310 provides multiplexing between logical and transport channels. The MAC sublayer 310 is also responsible for allocating the various radio resources (e.g., resource blocks) in one cell among the pieces of user equipment. The MAC sublayer 310 is also responsible for HARQ operations. Layer 3 (L3) 318 is above Layer 2 308 and is responsible for packet forwarding including routing through intermediate routers. Layer 3 318 may comprise a radio resource control (RRC) sublayer 316 and a non-access stratum (NAS) sublayer 320 in the control plane and the IP layer (not shown) in the user plane. The RRC sublayer 316 provides connection establishment and release functions, broadcast of system information, radio bearer establishment, reconfiguration and release, RRC connection mobility procedures, paging notification and release and outer loop power control, etc. The NAS sublayer 320 is used to manage the establishment of communication sessions and for maintaining continuous communications with the user equipment as it moves.

According to embodiments of the disclosure, the OTA protocol stack may refer to the protocol stack within the control plane of the Layer 2 and the Layer 3 of a protocol architecture. Therefore, taking the LTE protocol stack illustrated in FIG. 3 as an example, the filtering rules may be associated with one or more of the MAC sublayer 310, the RLC sublayer 312, the PDCP sublayer 314, the RRC sublayer 316, or the NAS sublayer 320. It should be appreciated that hereinafter within different contexts, the terms “layer” and “sublayer” may be used alternatively and the choice or non-choice of either term does not necessarily denote any actual difference in meaning.

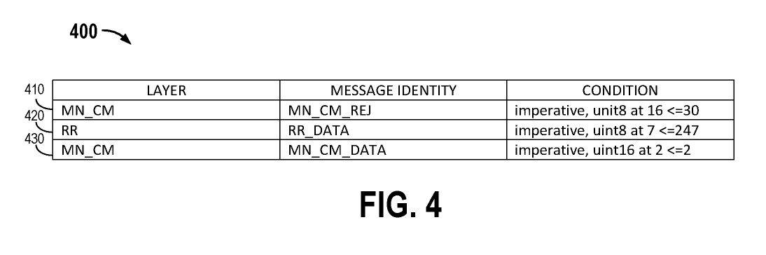

Referring to FIG. 4, a diagram 400 illustrating example filtering rules are shown. Each rule may at least indicate a specific (sub)layer of the protocol stack, a message identity (i.e., the type of the payload), and a condition that a legitimate payload should satisfy. Therefore, within the layer associated with a filtering rule, if a payload as identified by the message identity does not satisfy the condition, the payload is to be discarded according to the filtering rule. Although example rules described herein are in relation to the GSM protocol stack, it should be appreciated that the embodiments of the disclosure are not limited by any particular mobile network OTA protocol stack. As seen in FIG. 4, example rule 410 is associated with the layer MN_CM (Mobile Network—Call Management) within Layer 3. It indicates that for a payload of the type MN_CM_REJ, the 8 bits beginning from the 16th byte of the imperative section, if taken as an unsigned 8-bit integer, should be less than or equal to 30, when expressed in decimal. Similarly, rule 420 is associated with the layer RR (Radio Resource) within Layer 3. It indicates that for a payload of the type RR_DATA, the 8 bits beginning from the 7th byte of the imperative section, if taken as an unsigned 8-bit integer, should be less than or equal to 247. Moreover, rule 430 is associated with the layer MN_CM. It indicates that for a payload of the type MN_CM_DATA, the 16 bits beginning from the 2nd byte of the imperative section, if taken as an unsigned 16-bit integer, should be less than or equal to 2.

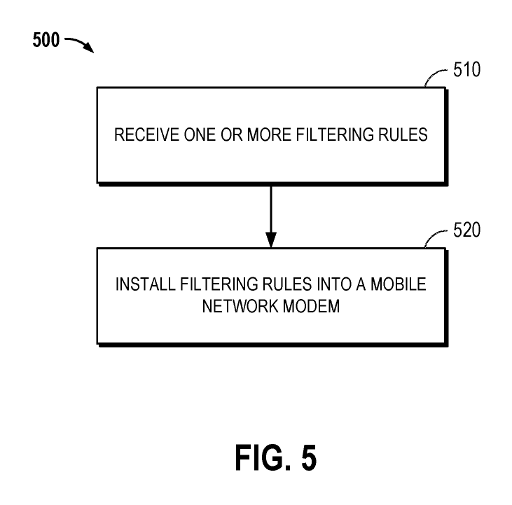

Referring to FIG. 5, a flowchart illustrating an example method 500 for installing one or more filtering rules into a mobile network modem is shown. At block 510, the one or more filtering rules may be received. The filtering rules may be in the form of a compiled binary ruleset file and may be received from a service provider or a device manufacturer. The ruleset file may be digitally signed by its author to ensure its trustworthiness. At block 520, the filtering rules may be installed into a mobile network modem. The installation may be effected without updating or changing the firmware of the mobile network modem. In one embodiment, the filtering rules may be installed using MI. The installed filtering rules may be stored within the mobile network modem in an SFS. Optionally, the installed filtering rules may be removed in the event an incorrectly-constructed filtering rule causes malfunctioning in the mobile network modem. It should be appreciated that the rules may be stored in a permanent storage that does not necessarily need to be secure and may be in a MPSS or APSS.

The filtering rules may be layer-specific. In other words, each filtering rule may be associated with a specific layer among the different layers of the protocol stack. Further, each filtering rule may specify a type of payload and a condition for the type of payload.

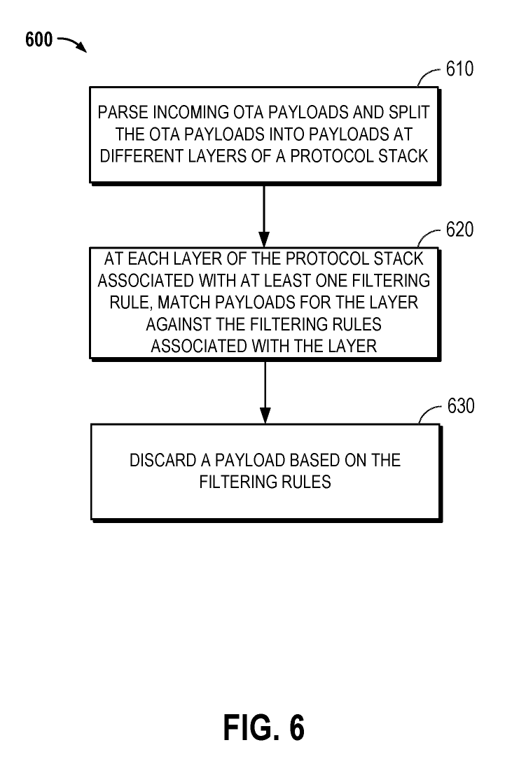

Referring to FIG. 6, a flowchart illustrating an example method 600 for filtering incoming OTA payloads is shown. At block 610, incoming OTA payloads may be parsed and split into payloads at the different layers of a protocol stack. At block 620, at each layer of the protocol stack that is associated with at least one filtering rule, payloads for the layer may be matched against the filtering rules associated with the layer. Hooks may be added to the protocol stack to gain access to payloads at each layer of the protocol stack. Moreover, a Berkeley Packet Filter may be utilized to find the matching payloads according to the filtering rules. At block 630, a payload may be discarded based on the filtering rules. A payload for the layer may be discarded if one of the filtering rules associated with the layer indicates that the payload should be discarded. A discarded payload may be removed from any further processing.

One embodiment of the disclosure is related to a device comprising a mobile network modem, a memory, and a processor coupled to the memory, the processor to: receive one or more filtering rules, and installing filtering rules into the mobile network modem, wherein each filtering rule is associated with a layer of an over-the-air (OTA) protocol stack and specifies a type of payload and one or more conditions for the payload.

Therefore, by utilizing the embodiments of the disclosure described herein, filtering rules may be installed into a mobile network modem, and malicious or otherwise problematic OTA payloads may be found and discarded based on the filtering rules. Using layer-specific rules reduces the complexity of the rules and the required processing resources, and keeps the overhead to a minimum for layers that do not have any associated rules. The rules may be easily removed in the event an incorrectly-constructed rule prevents the normal functioning of the mobile network modem.

It should be appreciated that aspects of the disclosure previously described may be implemented in conjunction with the execution of instructions (e.g., applications) by processor 101 of device 100, as previously described. Particularly, circuitry of the device, including but not limited to processor, may operate under the control of an application, program, routine, or the execution of instructions to execute methods or processes in accordance with embodiments of the disclosure (e.g., the processes of FIGS. 5 and 6). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

Methods described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

Example methods, apparatuses, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeroes). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method for installing one or more filtering rules, comprising:
receiving the filtering rules; and
installing the filtering rules into a mobile network modem, wherein each filtering rule is associated with a layer of an over-the-air (OTA) protocol stack and specifies a type of payload and one or more conditions for the payload.

2. The method of claim 1, further comprising:
parsing incoming OTA payloads and splitting the incoming OTA payloads into payloads at different layers of the OTA protocol stack;
at each layer of the OTA protocol stack that is associated with at least one filtering rule, matching payloads for the layer against the filtering rules associated with the layer; and
discarding an OTA payload based on the filtering rules.

3. The method of claim 2, wherein hooks are added to the OTA protocol stack to gain access to OTA payloads at one or more layers of the OTA protocol stack.

4. The method of claim 2, wherein at each layer of the OTA protocol stack, the payloads for the layer are matched against the filtering rules associated with the layer using a packet filter.

5. The method of claim 1, wherein the OTA protocol stack is one of a Global System for Mobile Communications (GSM) protocol stack, a Code Division Multiple Access (CDMA) protocol stack, a Universal Mobile Telecommunications System (UMTS) protocol stack, a CDMA2000 protocol stack, or a Long-Term Evolution (LTE) protocol stack.

6. The method of claim 1, wherein a compiled binary ruleset file comprises the filtering rules, and wherein the binary ruleset file is provided by a service provider or a device manufacturer and is digitally signable.

7. The method of claim 1, wherein the installing of the filtering rules is effected without change to a firmware of the mobile network modem.

8. The method of claim 1, wherein the installing of the filtering rules is performed using a Mobile Station Modem (MSM) Interface (MI).

9. The method of claim 1, wherein the installed filtering rules are stored in a permanent storage.

10. The method of claim 1, further comprising removing the installed filtering rules from the mobile network modem.

11. A device, comprising:
a mobile network modem;
a memory; and
a processor coupled to the memory, the processor to:
receive one or more filtering rules, and
install the filtering rules into the mobile network modem, wherein each filtering rule is associated with a layer of an over-the-air (OTA) protocol stack and specifies a type of payload and one or more conditions for the payload.

12. The device of claim 11, wherein the processor is further to:
parse incoming OTA payloads and split the incoming OTA payloads into payloads at different layers of the OTA protocol stack,
at each layer of the OTA protocol stack that is associated with at least one filtering rule, match payloads for the layer against the filtering rules associated with the layer, and
discard an OTA payload based on the filtering rules.

13. The device of claim 12, wherein hooks are added to the OTA protocol stack to gain access to OTA payloads at one or more layers of the OTA protocol stack.

14. The device of claim 12, wherein at each layer of the OTA protocol stack, the payloads for the layer are matched against the filtering rules associated with the layer using a packet filter.

15. The device of claim 11, wherein the OTA protocol stack is one of a Global System for Mobile Communications (GSM) protocol stack, a Code Division Multiple Access (CDMA) protocol stack, a Universal Mobile Telecommunications System (UMTS) protocol stack, a CDMA2000 protocol stack, or a Long-Term Evolution (LTE) protocol stack.

16. The device of claim 11, wherein a compiled binary ruleset file comprises the filtering rules, and wherein the binary ruleset file is provided by a service provider or a device manufacturer and is digitally signable.

17. The device of claim 11, wherein the installing of the filtering rules is effected without change to a firmware of the mobile network modem.

18. The device of claim 11, wherein the installing of the filtering rules is performed using a Mobile Station Modem (MSM) Interface (MI).

19. The device of claim 11, wherein the installed filtering rules are stored in a permanent storage.

20. The device of claim 11, wherein the processor is further to remove the installed filtering rules from the mobile network modem.

21. An apparatus for installing one or more filtering rules, comprising:
means for receiving the filtering rules; and
means for installing the filtering rules into a mobile network modem, wherein each filtering rule is associated with a layer of an over-the-air (OTA) protocol stack and specifies a type of payload and one or more conditions for the payload.

22. The apparatus of claim 21, further comprising:
means for parsing incoming OTA payloads and splitting the incoming OTA payloads into payloads at different layers of the OTA protocol stack;
at each layer of the OTA protocol stack that is associated with at least one filtering rule, means for matching payloads for the layer against the filtering rules associated with the layer; and
means for discarding an OTA payload based on the filtering rules.

23. The apparatus of claim 22, wherein hooks are added to the OTA protocol stack to gain access to OTA payloads at one or more layers of the OTA protocol stack.

24. The apparatus of claim 22, wherein at each layer of the OTA protocol stack that is associated with at least one filtering rule, the payloads for the layer are matched against the filtering rules associated with the layer using a packet filter.

25. The apparatus of claim 21, wherein the OTA protocol stack is one of a Global System for Mobile Communications (GSM) protocol stack, a Code Division Multiple Access (CDMA) protocol stack, a Universal Mobile Telecommunications System (UMTS) protocol stack, a CDMA2000 protocol stack, or a Long-Term Evolution (LTE) protocol stack.

26. A non-transitory computer-readable medium comprising code which, when executed by a processor, causes the processor to perform a method comprising:
receiving one or more filtering rules; and
installing the filtering rules into a mobile network modem, wherein each filtering rule is associated with a layer of an over-the-air (OTA) protocol stack and specifies a type of payload and a condition for the type of payload.

27. The non-transitory computer-readable medium of claim 26, further comprising code for:
parsing incoming OTA payloads and splitting the incoming OTA payloads into payloads at different layers of the OTA protocol stack;
at each layer of the OTA protocol stack that is associated with at least one filtering rule, matching payloads for the layer against the filtering rules associated with the layer; and
discarding an OTA payload based on the filtering rules.

28. The non-transitory computer-readable medium of claim 27, wherein hooks are added to the OTA protocol stack to gain access to OTA payloads at one or more layers of the OTA protocol stack.

29. The non-transitory computer-readable medium of claim 27, wherein at each layer of the OTA protocol stack that is associated with at least one filtering rule, the payloads for the layer are matched against the filtering rules associated with the layer using a packet filter.

30. The non-transitory computer-readable medium of claim 26, wherein the OTA protocol stack is one of a Global System for Mobile Communications (GSM) protocol stack, a Code Division Multiple Access (CDMA) protocol stack, a Universal Mobile Telecommunications System (UMTS) protocol stack, a CDMA2000 protocol stack, or a Long-Term Evolution (LTE) protocol stack.
